(19) United States
(12) Patent Application Publication
(10) Pub. No.: US 2013/0195294 A1
(43) Pub. Date: Aug. 1, 2013

(54) HEARING INSTRUMENT AND METHOD FOR MANUFACTURING A HEARING INSTRUMENT

(71) Applicants: ANTON GEBERT, KLEINSENDELBACH (DE); ULI GOMMEL, SINGAPORE (SG); HOLGER KRAL, FURTH (DE); FRANK NAUMANN, ERLANGEN (DE)

(72) Inventors: ANTON GEBERT, KLEINSENDELBACH (DE); ULI GOMMEL, SINGAPORE (SG); HOLGER KRAL, FURTH (DE); FRANK NAUMANN, ERLANGEN (DE)

(73) Assignee: SIEMENS MEDICAL INSTRUMENTS PTE. LTD., Singapore (SG)

(21) Appl. No.: 13/587,529

(22) Filed: Aug. 16, 2012

Related U.S. Application Data
(60) Provisional application No. 61/563,873, filed on Nov. 28, 2011.

(51) Int. Cl. H04R 25/00

(52) U.S. Cl. CPC H04R 25/604
USPC 381/312

(57) ABSTRACT

A hearing instrument has a basic frame with a cavity. A microphone is inserted in the cavity such that a back volume is defined. A coating of electrically conducting material is applied to the surface of the cavity to provide an electromagnetic shielding for the microphone. The electromagnetically shielded microphone is thus not disposed in a separate microphone housing, but rather directly integrated into the hearing instrument.

### CROSS-REFERENCE TO RELATED APPLICATION

This application claims the benefit, under 35 U.S.C. §119(e), of provisional patent application No. 61/563,873 filed Nov. 28, 2011; the prior application is herewith incorporated by reference in its entirety.

### BACKGROUND OF THE INVENTION

1. Field of the Invention

This invention relates to a hearing instrument with a microphone and to a method for manufacturing such a hearing instrument.

A hearing instrument, for example a hearing aid, needs a microphone to receive acoustical signals from the environment. These microphones must be small to manufacture small hearing instruments. The hearing aid can for example be of the so-called behind-the-ear (BTE) type.

Currently hearing instruments have electret microphones with a separate housing, e.g. a metal housing, which often has the geometric shape of a box or a cylinder. The microphone housing is integrated into the housing of the hearing instrument. A microphone housing made of a metal provides electromagnetic compatibility (EMC), i.e. the metal housing acts as an EMC shield.

Within the housing there is disposed a membrane and electronic components. The membrane divides the housing into two volumes in front of and behind the membrane, respectively. These two volumes are referred to as back volume and front volume. Both volumes have a high impact on the performance of the microphone. The housing is assembled into a basic frame which keeps the microphone in a certain position. This basic frame connects the microphone housing to the housing of the hearing instrument and, thus, determines the position of the microphone housing in the hearing instrument. The basic frame is usually made of plastic.

Commonly assigned U.S. Pat. No. 7,263,194 B2 and its European counterpart patent application EP 1 517 584 A2 describe a hearing aid comprising a microphone without a separate microphone housing. Instead, the microphone housing is an integrated part of the hearing aid housing itself.

### SUMMARY OF THE INVENTION

It is an object of the invention to provide a hearing instrument and a related manufacturing method which overcome a variety of the disadvantages of the heretofore-known devices and methods of this general type and which provide for an electromagnetic shielding for a microphone in a hearing aid without a separate microphone housing made of metal.

With the foregoing and other objects in view there is provided, in accordance with the invention, a hearing instrument, comprising:
a basic frame having a cavity formed therein, the cavity having a surface;
a microphone inserted into the cavity, the microphone together with the cavity defining a back volume of the microphone; and
a coating of an electrically conducting material applied to the surface of the cavity.

With the above and other objects in view there is also provided, in accordance with the invention, a method for manufacturing a hearing instrument, the method which comprises:
providing a basic frame with a cavity;
applying a coating of electrically conducting material to a surface of the cavity; and
inserting a microphone into the cavity, with the microphone and the cavity together defining a back volume of the microphone.

By providing a coating of electrically conducting material, e.g. a metal, to the surface of the cavity into which the microphone is inserted, an electromagnetic shielding is provided in an easy manner. This shielding effectively prevents electromagnetic influences and interference signals to affect the microphone.

The acoustic properties of the hearing aid are improved by arranging the microphone in the cavity of the basic frame such that a membrane of the microphone forms part of a closed surface which seals the cavity. Thereby the back volume is acoustically sealed.

Preferably the microphone is not directly inserted into the cavity, but rather attached to a microphone carrier, which is connected to the basic frame such that the back volume is sealed. The microphone carrier can be shaped as required more easily and—as a larger structure than the rather small microphone itself—handled more easily.

The microphone carrier can also include additional electronic components, e.g. for sound processing. This helps to further reduce the required space and to insert or exchange the sound carrier including the microphone and electrical components as one unit.

By soldering the microphone carrier into the cavity a continuous electromagnetic shielding can be provided excluding any gap between the coating of the cavity and microphone carrier. The solder paste provides an electrically conducting contact between the coating and the carrier. Alternatively, an electrically conducting glue can be used to attach the microphone carrier to the basic frame.

The electrically conducting material can be applied either to the inside or to the outside of the cavity. Both alternatives provide an effective electromagnetic shielding.

Preferably the coating is extended beyond the cavity on the outside surface of the basic frame to provide a reliably shielding.

By making the basic frame as a molded interconnected device (MID) the coating is applied easily and in various shapes of the cavity. This makes it possible to use the limited space available efficiently as back volume. Alternatively the electrically conductive coating can be applied by means of vapor coating.

The surface area of the basic frame which is to be coated can easily be defined by laser direct structuring (LDS).

Although the invention has been mostly addressed in the embodiment of a hearings instrument the invention can also be embodied as method for manufacturing such a hearing instrument. Features and advantages described in reference to the device will therefore also imply corresponding features and advantages in the context of the method, and vice versa.

Other features which are considered as characteristic for the invention are set forth in the appended claims.

Although the invention is illustrated and described herein as embodied in a hearing instrument and method for manufacturing a hearing instrument, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a side view onto a hearing aid with a microphone;

FIG. 2 is a top view onto a microphone carrier with a microphone, an electrical component and electrical contacts;

FIG. 3 is a cross-sectional side view of the microphone carrier according to FIG. 2 inserted into a cavity of a basic frame of a hearing aid; and

FIG. 4 is a flowchart illustration of a method for manufacturing a hearing aid.

### DESCRIPTION OF THE INVENTION

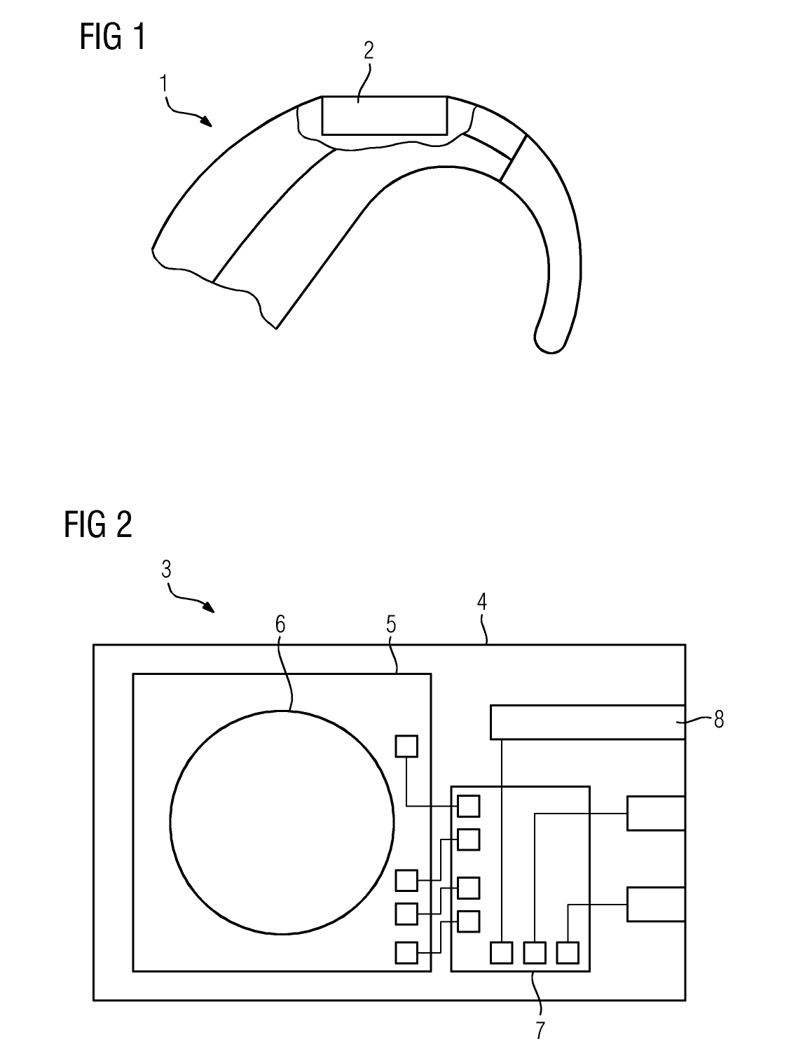

Referring now to the figures of the drawing in detail and first, particularly, to FIG. 1 thereof, there is shown a hearing instrument 1 in the form of a behind-the-ear (BTE) hearing aid. The housing of the device is partly cut open to illustrate the position of a microphone assembly 2.

As shown, the hearing aid can be of the BTE type. However, the microphone assembly 2 can also be used in a separate outer housing which is electrically connected to the main body of the hearing aid. Such a two-part design of a hearing aid is known in the art.

The hearing instrument 1 comprises a basic frame, often called “neutral base,” which provides the basic structure of hearing instrument 1. The components of the hearing aid 1 are connected to this frame. The basic frame will include cavities which are adapted to receive at least some of these components. Components might have separate cavities in the frame or might be included together into a bigger space.

The hearing instrument may contain one or more microphone arrangements, which can be integrated in separate cavities.

FIG. 2 shows the basic components of a microphone arrangement 3 integrated onto a microphone carrier 4. The microphone arrangement 3 includes a silicon microphone 5 with membrane 6 and an electric component 7 in form of an application-specific integrated circuit (ASIC). The ASIC 7 is connected to electric contacts 8 on the right of the microphone carrier 4. An electric signals of the silicon microphone 5 can be send to other parts of the hearings instruments 1 via these contacts 8 for further processing.

Although in this embodiment a silicon microphone 5 is used, with this invention either electret or silicon microphones can be used. Silicon microphones have the advantage to be less sensitive to structure-borne noise and hence they are better suited to be directly integrated into the hearing aid 1 without any damping arrangement.

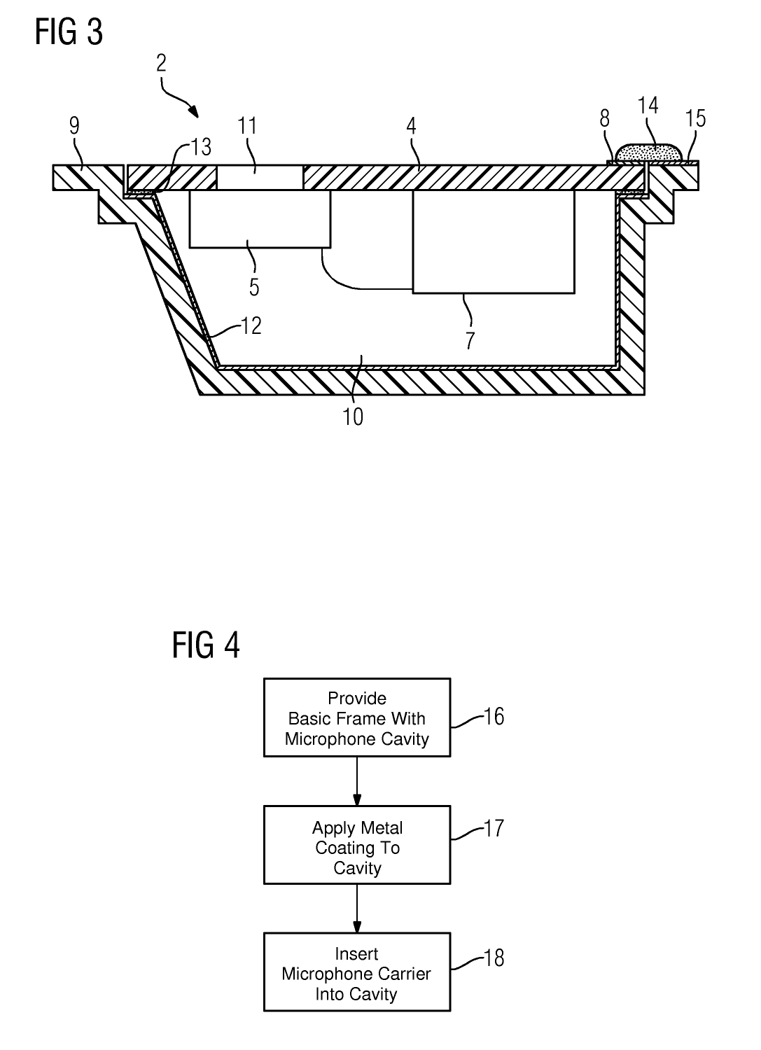

FIG. 3 shows how the microphone arrangement 3 of FIG. 2 is integrated into the basic frame 9 of the hearing aid 1. Only a part of the basic frame 9 is shown which can have further cavities for further microphone and other components. The microphone carrier 4 is integrated into the cavity, such that it closes the opening of the cavity. The ASIC 7 is connected to other components of the hearing instrument via the electric contacts 8.

In this cross-sectional view one can see that the silicon microphone 5 is placed behind a sound passage 11 through the microphone carrier 4. This allows sound from outside of the hearing instrument 1 to pass through the microphone carrier 4 to the membrane 6 of the silicon microphone 5.

The microphone is inserted into a cavity of the basic frame 9, which is usually made of plastic, which does not provide an EMC shielding.

The inside surface of the cavity is coated with a metalized EMC structure 12, which provides an EMC shielding. The coating 12 can be made of a metal or alternatively of any other electrically conducting material. In fact, coating can be applied on the inside or the outside of the cavity. Alternatively, the part of the basic frame 9 forming the cavity can be made conducting by any means other than coating.

Additionally the microphone carrier 4 is connected to the basic frame 9 by soldering or gluing. This connection improves the EMC shield in that it closes any gap between the basic frame and the microphone carrier 4. Solder paste connections 13 connect the metal coating 12 with the microphone carrier 4.

To solder the microphone carrier 4 to the basic frame 9, solder paste is dispensed around the flange of the plastic cavity, afterwards the microphone carrier 4 is placed and both parts are soldered together in a solder oven. Soldering is anyway required for other purposed so this option would reduce the number of required steps.

The microphone 5 is included into the cavity such that the membrane 6 forms part of a closed surface which seals the cavity acoustically. Preferably this surface is also made part of the EMC shield so that the microphone 5 is enclosed completely by this EMC shield. In this embodiment the closed surface is at least partly defined by the microphone carrier 4, which can for example be a mostly flat structure, usually a flat printed-circuit board (PCB). This PCB may be equipped with an additional electrically conductive layer as part of the EMC shielding. The metallic coating 12 of the cavity together with the electrically connected conductive layer in the PCB of the microphone carrier 4 form the EMC shield.

On the outside connection between the basic frame 9 and the microphone carrier 4 an additional solder paste connection 14 can be made, which electrically connects the electric contacts 8 of the microphone carrier 4 with corresponding electric connectors 15 on the basic frame 9. In this embodiment of the invention the electronic contacts 8 are arranged on a different side of the microphone carrier 4 compared to FIG. 2.

The microphone 5 is included in the hearing aid 1 without a separate microphone housing directly into the microphone cavity of the basic frame 9. At least the membrane 6 of the microphone 5 will be included into this cavity. Additionally the electronic component 7 for processing the electronic signals for the microphone might also be included into this cavity, as shown in this embodiment. The basic frame 9 is made of plastic, but it can also be made of any other suitable material.

The microphone cavity has an opening into which the microphone carrier 4 is inserted. It is inserted and attached to the basic frame 9 such that membrane 6 of the microphone 5 is part of a sealing surface which separates the front volume from the back volume 10. In fact, the arrangement in this embodiment is such that the front volume is not included in the basic frame 9. However, in an alternative embodiment the front volume can be included in the basic frame 9. In such a case, the front volume will have an acoustic connection to the outside of the hearing aid 1.

The majority of the cavity is used a back volume 10. Generally it is the aim to make to back volume 10 as large as possible to improve the acoustic properties of the hearing aid 1. Another part of the cavity could be used as front volume, so that both front and back volume 10 are realized within the cavity.

A separate housing for the microphone 5 can be avoided, which reduces the costs and the constructional complexity of the hearing instrument 1.

By integrating the microphone 5 into the basic frame 9 the shape of the complete microphone assembly is determined primarily by the cavity. It is easy to adjust the shape of the cavity to the shape of hearing instrument 1 and/or the arrangement of other components as to use the available space as efficient as possible. The shape of the microphone arrangement is not anymore predetermined by the shape of the separate microphone housing. For a given shape of the hearing instruments 1 the total volume of the front and/or back volume 10 can be increased, which is beneficial for the acoustical properties.

Therefore it is now possible to build smaller hearing instruments 1 with same microphone performance or hearing instruments 1 of same size with better microphone performance.

Additionally the freedom of shaping the cavity, and hence the front and/or back volume 10, allows to customize the acoustic properties. This can be used for so-called frequency-shaping.

The complexity of the microphone integration is reduced since fewer parts are required, for example less complex PCBs.

The robustness of the hearing instrument 1 is increased since there are fewer parts, especially moving parts.

The cost is reduced, since it is easier to manufacture the hearing instrument 1. Fewer PCBs are required.

Referring now to FIG. 4, there are illustrated the basic steps of a method of manufacturing a hearing instrument 1.

In the first step 16 the basic frame 9 with the cavity to receive the microphone carrier 4 is provided. In the second step 17 the metal coating 12 is applied to the inner surface of the cavity. In the third step the microphone carrier 4 with the microphone 5 is inserted into the cavity, such that the microphone carrier 4 together with the cavity define the back volume 10 of the microphone 5.

The basic frame 9 is preferably made as so-called “Molded Interconnected Device” (MID). Preferably it is manufactured using Laser Direct Structuring (LDS). By using LDS a designated surface area of the basic frame 9 is prepared to receive the metal coating 12.

With this technology it is possible to create local closed metalized structures 12 at plastic parts. This structure forms part of the EMC shield.

1. A hearing instrument, comprising:
a basic frame having a cavity formed therein, said cavity having a surface;
a microphone inserted into said cavity, said microphone together with said cavity defining a back volume of said microphone; and
a coating of an electrically conducting material applied to said surface of said cavity.

2. The hearing instrument according to claim 1, wherein said microphone comprises a membrane disposed in said cavity to form a part of a closed surface sealing said cavity acoustically.

3. The hearing instrument according to claim 1, wherein said microphone is attached to a microphone carrier, and said microphone carrier is connected to said basic frame to seal said back volume.

4. The hearing instrument according to claim 3, which comprises additional electronic components mounted to said microphone carrier.

5. The hearing instrument according to claim 3, wherein said microphone carrier is soldered into said cavity.

6. The hearing instrument according to claim 1, wherein said electrically conducting material is a metal.

7. The hearing instrument according to claim 1, wherein said electrically conducting material is applied to an inside or to an outside of said cavity.

8. The hearing instrument according to claim 1, wherein said coating extends beyond said cavity on an outside surface of said basic frame.

9. The hearing instrument according to claim 1, wherein said basic frame is made as a molded interconnected device.

10. The hearing instrument according to claim 1, wherein said coating is a laser direct structuring coating.

11. A method for manufacturing a hearing instrument, the method which comprises:
providing a basic frame with a cavity;
applying a coating of electrically conducting material to a surface of the cavity; and
inserting a microphone into the cavity, with the microphone and the cavity together defining a back volume of the microphone.

12. The method according to claim 11, wherein the inserting step comprises inserting the microphone into the cavity attached to a microphone carrier, and connecting the microphone carrier to the basic frame to thereby seal the back volume.

13. The method according to claim 12, which comprises soldering the microphone carrier into the cavity.

14. The method according to claim 11, which comprises forming the basic frame with the coating as a molded interconnected device using laser direct structuring.

15. The method according to claims 11, which comprises adapting the method steps to manufacturing a hearing instrument according to claim 1.
